(19) United States
(12) Patent Application Publication
(10) Pub. No.: US 2014/0275323 A1
(43) Pub. Date: Sep. 18, 2014

(54) OLIGOMER-GRAFTED NANOPARTICLES AND ADVANCED COMPOSITE MATERIALS

(71) Applicants: Francis R. Thibodeau, Oakland, CA (US); Yuqiang Qian, New Brighton, MN (US); Andreas Stein, Saint Paul, MN (US); Christopher W. Macosko, Minneapolis, MN (US)

(72) Inventors: Francis R. Thibodeau, Oakland, CA (US); Yuqiang Qian, New Brighton, MN (US); Andreas Stein, Saint Paul, MN (US); Christopher W. Macosko, Minneapolis, MN (US)

(21) Appl. No.: 14/212,401

(22) Filed: Mar. 14, 2014

Related U.S. Application Data
(60) Provisional application No. 61/791,132, filed on Mar. 15, 2013.

(51) Int. Cl. C08K 9/04; C09C 3/08

(52) U.S. Cl. CPC C08K 9/04; C09C 3/08
USPC 522/177; 549/543; 549/215; 568/817; 564/458; 556/425; 106/415; 106/487; 106/499; 106/505; 106/481; 525/315; 549/513

(57) ABSTRACT

Oligomer-grafted nanofiller compositions and composites including oligomer-grafted nanofillers are disclosed. An oligomer-grafted nanofiller composition for disposition in a polymer matrix, the polymeric matrix comprising polymers derived from a plurality of polymerizable units, can include a nanoparticle, one or more coupling groups bonded to the nanoparticle; and one or more oligomers bonded to the one or more coupling groups. In an embodiment the oligomer is derived from two or more polymerizable units, at least one polymerizable unit being at least substantially similar to at least one of the polymerizable units of the polymer matrix. In another embodiment the oligomer comprises two or more polymerizable units and improves dispersion, interfacial strength, or both dispersion and interfacial strength between the nanoparticle and the polymer matrix. Composites and methods are also disclosed.

### CROSS REFERENCE TO RELATED APPLICATIONS

This application claims priority to U.S. Provisional Patent Application No. 61/791,132, filed Mar. 15, 2013.

### TECHNICAL FIELD

The disclosed inventions are in the field of composite materials and nanomaterials for improving the properties of polymeric materials.

### BACKGROUND

Polymeric composite materials are used in a wide variety of applications, from transportation vehicles to sporting equipment, and a variety of mechanical parts. Owing to their relatively low density and high strength, polymeric composite materials are advantageously used as a replacement for heavier metallic materials. However polymeric composite materials lack certain desirable properties compared to metals, such as high impact strength (e.g., “toughness”), electrical conductivity, and barrier against molecular transport. Previous attempts have been made to include filler particles in the polymeric composite materials to improve these properties. However the mechanical properties of such composite materials often suffer as a result of incompatibility between the filler particle and the polymeric matrix. Accordingly, there is a need to provide filler particles that are more compatible with polymeric matrices. There is also a need to improve the mechanical properties of polymeric composite materials.

### SUMMARY

Provided herein are oligomer-grafted nanofiller compositions for disposition in a polymer matrix, the polymeric matrix comprising polymers derived from a plurality of polymerizable units, the nanofiller composition comprising: a nanoparticle; one or more coupling groups bonded to the nanoparticle; and one or more oligomers bonded to the one or more coupling groups, wherein the oligomers are derived from two or more polymerizable units, at least one polymerizable unit being at least substantially similar to at least one of the polymerizable units of the polymer matrix.

Also provided are oligomer-grafted nanofiller compositions for disposition in a polymer matrix, the polymeric matrix comprising two or more polymerizable units, the nanofiller composition comprising: a nanoparticle; one or more coupling groups bonded to the nanoparticle; and one or more oligomers bonded to the one or more coupling groups, wherein the oligomer comprises two or more polymerizable units and improves dispersion, interfacial strength, or both dispersion and interfacial strength between the nanoparticle and the polymer matrix.

Also provided are composites comprising a composition of an oligomer-grafted nanofiller and polymer composite having a polymer matrix and one or more oligomer-grafted nanofillers dispersed within the polymer matrix. The oligomer-grafted nanofiller can include a nanoparticle, one or more coupling groups bonded to the nanoparticle, and one or more oligomers bonded to the one or more coupling groups.

Furthermore, the present disclosure provides methods for making oligomer-grafted nanofillers and composites. The methods for making oligomer-grafted nanofillers can include grafting a nanoparticle with one or more oligomers to form an oligomer-grafted nanofiller. The methods for making an oligomer-grafted nanofiller can also include reacting a nanoparticle with one or more coupling agent to form a coupling agent-bonded nanoparticle and reacting the coupling agent-bonded nanoparticle with one or more oligomers to form an oligomer-grafted nanofiller.

In further embodiments, there are provided composites, comprising: a polymer matrix; and one or more oligomer-grafted nanofillers dispersed within the polymer matrix, wherein the oligomer-grafted nanofillers comprise a nanoparticle, one or more coupling groups bonded to the nanoparticle, and one or more oligomers bonded to the one or more coupling groups.

Also provided are methods for making composites, comprising dispersing an oligomer-grafted nanofiller in a polymer matrix, wherein the polymer matrix comprises one or more polymerizable units and effectuating bonding between the oligomers and the polymer matrix. The oligomer-grafted nanofiller can include a nanoparticle and one or more oligomers covalently bonded to the nanoparticle, optionally through a coupling agent and the one or more oligomers can be derived from two or more polymerizable units, at least one polymerizable unit can be at least substantially similar to at least one of the polymerizable units of the polymer matrix.

Methods for making a composite are also provided, the methods comprising dispersing an oligomer-grafted nanofiller in a fluid comprising one or more monomers, the oligomer portion of the oligomer-grafted nanofiller being derived from at least one polymerizable unit corresponding to the one or more monomers and polymerizing the monomer.

In addition articles made from the oligomer-grafted nanofiller composite provided herein are also disclosed.

### BRIEF DESCRIPTION OF THE DRAWINGS

The present disclosure is further understood when read in conjunction with the appended drawings. For the purpose of illustrating the subject matter, there are shown in the drawings exemplary embodiments of the subject matter; however, the presently disclosed subject matter is not limited to the specific methods, devices, and systems disclosed. In addition, the drawings are not necessarily drawn to scale. In the drawings:

FIG. 1 illustrates a method (100) for attaching coupling agents (110) to a nanoparticle (105) to form a nanoparticle that is bonded to one or more coupling agents (115).

FIG. 2 illustrates a method (120) for attaching oligomers (125) to the coupling agents (110) that are attached to a nanoparticle (105) in a nanoparticle that is bonded to one or more coupling agents (115) to form an oligomer-grafted nanofiller (130).

FIG. 3 illustrates a method (200) for attaching a dendritic coupling agent (210) to a nanoparticle (205) to form a nanoparticle that is bonded to one or more dendritic coupling agents (215) and subsequently attaching oligomers (225) to the dendritic coupling agents (210) of the nanoparticle that is bonded to one or more dendritic coupling agents (215) to form an oligomer-grafted nanofiller (230).

FIG. 4 illustrates a method (300) for dispersing oligomer grafted nanofillers (330) including a nanoparticle (305) and oligomers on the surface of the nanoparticle (305) forming an oligomer shell (335), adding the oligomer grafted nanofillers (330) to a solution of monomer (340) and polymerizing the monomers to form a composite material (345). As shown in the embodiment illustrated in FIG. 4, once the monomer solution has been polymerized, there is no visible interface between the polymerized shells (335) of the oligomer-grafted nanofillers (330) and the polymer matrix (350).

FIG. 5 illustrates a method of the functionalization of graphene oxide (GO) using methylene diphenyl diisocyanate (MDI) in a first step and amine-terminated polybutadiene-polyacrylonitrile oligomer (ATBN) in a second step.

FIG. 5A illustrates the chemical structure of ATBN.

FIG. 6 shows the FT-IR spectra of ATBN-GO, GO-NCO, and GO.

FIG. 7 shows the x-ray diffraction spectra of ATBN-GO, MDI-GO, and GO.

### DETAILED DESCRIPTION OF ILLUSTRATIVE EMBODIMENTS

The present invention may be understood more readily by reference to the following description taken in connection with the accompanying Figures and Examples, all of which form a part of this disclosure. It is to be understood that this invention is not limited to the specific products, methods, conditions or parameters described and/or shown herein, and that the terminology used herein is for the purpose of describing particular embodiments by way of example only and is not intended to be limiting of any claimed invention. Similarly, unless specifically otherwise stated, any description as to a possible mechanism or mode of action or reason for improvement is meant to be illustrative only, and the invention herein is not to be constrained by the correctness or incorrectness of any such suggested mechanism or mode of action or reason for improvement. Throughout this text, it is recognized that the descriptions refer both to the features and methods of making and using oligomer-grafted nanofillers and composite materials that include oligomer-grafted nanofillers, as well as the oligomer-grafted nanofillers and composite materials that include oligomer-grafted nanofillers themselves, and vice versa.

In the present disclosure the singular forms “a,” “an,” and “the” include the plural reference, and reference to a particular numerical value includes at least that particular value, unless the context clearly indicates otherwise. Thus, for example, a reference to “a material” is a reference to at least one of such materials and equivalents thereof known to those skilled in the art, and so forth.

When a value is expressed as an approximation by use of the descriptor “about,” it will be understood that the particular value forms another embodiment. In general, use of the term “about” indicates approximations that can vary depending on the desired properties sought to be obtained by the disclosed subject matter and is to be interpreted in the specific context in which it is used, based on its function. The person skilled in the art will be able to interpret this as a matter of routine. In some cases, the number of significant figures used for a particular value may be one non-limiting method of determining the extent of the word “about.” In other cases, the gradations used in a series of values may be used to determine the intended range available to the term “about” for each value. Where present, all ranges are inclusive and combinable. That is, references to values stated in ranges include every value within that range.

It is to be appreciated that certain features of the invention which are, for clarity, described herein in the context of separate embodiments, may also be provided in combination in a single embodiment. That is, unless obviously incompatible or specifically excluded, each individual embodiment is deemed to be combinable with any other embodiment(s) and such a combination is considered to be another embodiment. Conversely, various features of the invention that are, for brevity, described in the context of a single embodiment, may also be provided separately or in any sub-combination. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Finally, while an embodiment may be described as part of a series of steps or part of a more general structure, each said step may also be considered an independent embodiment in itself.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are described herein.

Oligomer-grafted nanofiller (OGN) compositions of the invention can be used for disposition in a polymer matrix that includes polymers derived from a plurality of polymerizable units. The nanofiller composition can include a nanoparticle, one or more coupling groups bonded to the nanoparticle, and one or more oligomers bonded to the one or more coupling groups. In an embodiment the oligomers can be derived from two or more polymerizable units where at least one polymerizable unit can be at least substantially similar to at least one of the polymerizable units of the polymer matrix. In another embodiment the oligomer comprises two or more polymerizable units and can improve dispersion, interfacial strength, or both dispersion and interfacial strength between the nanoparticle and the polymer matrix.

Suitable nanofillers (for example, graphene, graphene oxide, carbon nanotubes) can be grafted with single-type or multiple oligomer surface groups that are either identical in composition to the host polymer matrix or otherwise chosen to improve dispersion and/or interfacial strength with the host. Because of the resulting similarity between nanofiller and host matrix, high dispersion of nanofiller in the matrix can be achieved. The strong bond between filler and surface oligomer groups and the strong interactions between surface oligomer groups and the host polymer matrix ensure a strong interface between all components. Good dispersion and strong interfaces can ensure effective load transfer between the polymer matrix and the filler to enhance the toughness, stiffness, and dimensional stability of the composites. The approach also includes grafting a first oligomer type to aid in dispersion or interfacial strength and a second, or greater number of types, to achieve desirable materials properties such as toughening, etc.

Suitable nanoparticles can be selected from any particle having at least one characteristic dimension in the range of from about 1 nm to about 100 nm and that can be used as a filler in a polymer matrix. Suitable nanoparticles used herein can include a carbonaceous material, which, as used herein refers to a material having one or more carbon atoms. Suitable carbonaceous nanoparticles can include, but are not limited to, single-walled carbon nano-tubes, multi-walled carbon nanotubes, carbon nanofibers, graphene sheets, graphene oxide nanoparticles, graphite nanoparticles, fullerene particles, carbon blacks, or activated carbons. Suitable nanoparticles can also include metal oxides, such as silica, layered silicates, clays, ceramics, and layered chalcogenides. Nanoparticles that are useful in the invention can also include any combination or subcombination of the aforementioned materials.

As used herein, the term “coupling group” refers to any chemical functionality that serves to attach an oligomer to the surface of the nanoparticle. A coupling group can also be a reactive group that attaches to another coupling group that is bonded or otherwise attached to the nanoparticle. It is to be understood that the term coupling group, therefore, can refer to the entire moiety that serves to bridge the nanoparticle and one or more oligomers, and the term coupling agent can also refer to any subpart of the moiety that connects the nanoparticle and one or more oligomers. For example, a coupling group can include a first coupling group, also referred to as an anchoring group, that bonds directly to the nanoparticle and a second coupling group that bonds to the anchoring group and serves as the point of attachment for one or more oligomers. The coupling group or anchoring group can be a functionality on the surface of the nanoparticle that is intrinsic to the structure of the nanoparticle. For example, an intrinsic coupling group or anchoring group can include —OH, —COOH, or other reactive functionality, depending on the structure of the nanoparticle. Alternatively, the coupling group or anchoring group can be a reactive species that is attached to a nanoparticle by way of a chemical reaction. In some materials such as, for example, graphene, the density of intrinsic anchoring points can be quite low. It may be increased by chemical treatment that increases the number of intrinsic surface groups. For example, the coupling group or anchoring group can include —OH, —COOH, —NH₂, —C═C, —NCO, epoxide, or other reactive functionality. The coupling group or anchoring group can be bonded to the nanoparticle, such as covalently bonded or ionically bonded. As described above, a coupling group can be attached to the nanoparticle through another coupling group or anchoring group. For example, a coupling group includes, but is not limited to, organic silane, di-isocyanate, di-amine, quaternary amine, or other reactive functionality. The number of anchoring points for attachment of oligomer to the nanoparticle can also be increased by attaching branched surface groups that contain multiple points for attachment to enable dendritic growth. Thus, a coupling group can be dendritic and have multiple reactive sites such that one or more oligomers can be attached to it. Example dendritic coupling groups include, but are not limited to polyamine, polyisocyanate and polyol.

In OGN compositions of the invention, one or more oligomers can be attached to a coupling agent that is attached to a nanoparticle. That is, one oligomer can be bonded to one coupling agent that is bonded to the nanoparticle. Alternatively, more than one oligomer can each be bonded directly to a single coupling agent, or such as to multiple sites on a single coupling agent that is bonded to the nanoparticle, or one oligomer can be bonded directly to more than one coupling agent, such as through multiple sites on the single oligomer. One or more oligomers can be attached to one or more coupling agents by chemical bonding, such as covalent bonding or ionic bonding. For example, multifunctional crosslinking agents comprising n functional groups can be attached to the coupling agent, to provide n−1 functional groups for linking up to n−1 oligomers per coupling agent.

Suitable oligomers can be derived from 2 to about 200 polymerizable units, more preferably from about 10 to about 100 polymerizable units, and even more preferably from about 20 to about 50 polymerizable units. In terms of molecular weight, suitable oligomers can typically have a molecular weight in the range of from about 100 g/mol to about 10,000 g/mol, more preferably in the range of from about 500 g/mol to about 5,000 g/mol, and even more preferably in the range of from about 1000 g/mol to about 2,500 g/mol.

In certain embodiments, suitable oligomers can also refer to a polymer comprising in the range of from about 2 to about 100 polymerizable units. In some embodiments, suitable oligomers for use in OGN compositions of the invention can have from about 2 to about 100 polymerizable units, or from about 2 to about 80 polymerizable units, or from about 2 to about 60 polymerizable units, or from about 5 to about 40 polymerizable units, or from about 10 to about 20 polymerizable units. Oligomers can also be referred to herein as a low-molecular weight version of a corresponding polymer. The strength of interfacial interactions can be controlled by the chain length (molecular weight) of the oligomeric groups. For example, longer chain lengths can provide stronger van der Waals interactions with the polymer matrix.

An oligomer can be a homooligomer, wherein each of the polymerizable units is at least substantially the same, or can be a copolymer including two or more polymerizable units that are not substantially the same, or are substantially different. As used herein, “substantially the same,” or “substantially similar” in reference to polymerizable units refers to polymerizable units that have the same basic chemical structure, but may vary in one or more substituents without significantly affecting the chemical properties of the polymerizable unit. OGN compositions of the present invention can include oligomers that are one or more of the following types of copolymer: random, alternating, periodic, and block. Oligomers suitable for use in the OGN compositions of the invention include linear oligomers or branched oligomers.

While OGN compositions of the invention include at least one or more oligomers attached to the nanoparticle through a coupling group, preferably the amount of oligomers attached to the nanoparticle through a coupling group is sufficient to achieve complete or partial surface coverage of the nanoparticle. The strength of interfacial interactions can depend on the density of oligomeric surface groups surrounding the filler nanoparticle. For example, in a functionalization of a nanoparticle, oligomeric coverage can be described in terms of number of oligomers per area. For example, oligomeric coverage of a nanoparticle can be in a range of from about one oligomer per nm² to about 1 oligomer per 10,000 nm², or more preferably in a range of from about one oligomer per nm² to about one oligomer to about 1,000 nm². For example, in a functionalization of graphene nanoparticle, oligomeric coverage can be in a ratio of about one oligomer per every 100 to 200 surface carbon atoms, about one oligomer per 70 surface carbon atoms, or about one oligomer per every 40 surface carbon atoms. In other embodiments the number density of oligomers to surface carbon atoms can be as low as 1 oligomer per about 10,000 surface carbon atoms to as high as 1 oligomer per about 10 surface carbon atoms. It will be appreciated that the required number density per surface carbon atom or density per surface area to effect coverage of the surface of a nanoparticle generally decreases as the size (e.g., atomic mass) of the oligomer increases. Hence fewer lengthier oligomers can provide similar surface coverage as more, shorter, oligomers. The number of oligomers per surface area of nanoparticle can be measured by any method known to a person of skill in the art, including transmission electron microscopy.

The functionalization density of oligomer coverage of the nanoparticle surface can also be characterized by thermogravimetric analysis (TGA). In some embodiments a mass fraction of organic matter attributable to the surface oligomers (and any organic coupling agent to which they may be attached) is in a range from about 2% to about 90%, and more preferably in a range of from about 5% to about 80% based on total weight of the OGN. It will be appreciated that the mass fraction will depend on the molecular weight of the oligomers, and the higher the molecular weight of the oligomers, the higher the mass fraction of organic matter will be in OGNs. Similarly, it will be appreciated that the mass fraction will depend on the molecular weight to an organic coupling agent to which the oligomer is attached, if the oligomer is attached to the nanoparticle through an organic coupling agent.

OGN compositions can include one or more oligomers derived from two or more polymerizable units where at least one polymerizable unit can be at least substantially similar to at least one of the polymerizable units of the polymer matrix. An OGN composition of the invention that can be used as a filler in a polymer containing a single type of repeating unit, i.e., a homopolymer, can include one or more oligomeric groups that are a low-molecular weight version of the matrix polymer. For example, an OGN composition of the invention for use as a filler in polystyrene can include one or more oligomeric groups that are low-molecular weight polystyrene. For example, an OGN composition of the invention for use as a filler in polyethylene can include one or more oligomeric groups that are low-molecular weight polyethylene. An OGN composition of the invention that can be used as a filler in a polymer containing two or more substantially different polymerizable units, i.e., a copolymer can include one or more oligomers wherein at least one polymerizable unit of the two or more oligomers is at least substantially similar to each of the two or more substantially different polymerizable units of the polymeric matrix. Thus, an OGN composition of the invention that can be used as a filler in a copolymer can include one or more oligomeric groups that are each the low-molecular weight oligomer of each counterpart of the copolymer. That is, each oligomer group can include two or more of substantially the same polymerizable unit, that polymerizable unit can be the same as at least one polymerizable unit of the polymer matrix in which the OGN is intended to be used. For example, an OGN composition of the invention for use as a filler in polyethylene oxide-polystyrene can include one or more oligomeric groups that are low-molecular weight polyethylene oxide and one or more oligomeric groups that are low-molecular weight polystyrene. An OGN composition of the invention that can be used as a filler in a polymer containing a cross-linked network including different polymerizable units can include one or more oligomeric groups that are linear oligomers each composed of similar polymerizable units as the polymer matrix. These examples are illustrative only and are not meant to be limiting.

Suitable polymerizable units that comprise the oligomers can be selected from any type of polymerizable monomer, as well as combinations of monomers such as in a copolymerization or block-copolymerization. Examples of suitable monomers include, but are not limited to, any of the monomers that can be polymerized using free-radical polymerization, condensation polymerization, ring-opening polymerization, and the like. Suitable free-radical monomers include vinyl aromatic monomers (e.g., styrenes), dienes (e.g., butadiene and isoprene), acrylics, methacrylics, nitrogen-containing vinyl compounds such as vinylpyridines, and any combination thereof.

Suitable condensation polymers include, but are not limited to, polyesters (PEs), polyamides (PAs), and polycarbonates (PCs). Suitable polyesters include homo- or copolyesters that are derived from aliphatic, cyclo aliphatic or aromatic dicarboxylic acids and diols or hydroxycarboxylic acids. Non-limiting, exemplary polyesters include poly(ethylene terephthalate) (PET), poly(butylene terephthalate) (PBT), poly(ethylene naphthalate) (PEN), and poly(butylene naphthalate). Suitable polyamides include polyamides produced by polycondensing a dicarboxylic acid with a diamine, polyamides produced by polymerizing a cyclic lactam, and polyamides produced by co-polymerizing a cyclic lactam with a dicarboxylic acid/diamine salt. The polyamides include polyamide elastomer resins. Suitable polyamide elastomer resins include nylon 6, nylon 6-6, nylon 6-10, nylon 11, nylon 12, and co-polymers and blends of any two or more such polyamides. Suitable polycarbonates include, but are not limited to, aromatic polycarbonates produced by reactions of bisphenols with carbonic acid derivatives such as those made from bis-phenol A (2,2-bis(4-hydroxyphenyl)propane) and phosgene or diphenyl carbonate.

In another embodiment suitable oligomers comprise two or more polymerizable units and can improve dispersion, interfacial strength, or both dispersion and interfacial strength between the nanoparticle and the polymer matrix. A person of skill in the art will understand how to measure the dispersion of the OGN in the polymer matrix (and of the nanoparticle in the polymer matrix as a reference point). For example, any one or more of transmission electron microscopy, rheology, small angle X-ray scattering or X-ray diffraction methods can be used to quantify dispersion. For example, in rheology one can measure the gel point, which is the concentration of OGN at which the slope of G′ vs oscillation frequency approaches zero at low frequency, i.e., the percolation concentration of filler particles. As used herein, G′ is the storage modulus of a material determined using dynamic mechanical analysis. For OGNs prepared using graphene sheet nanoparticles or carbon nanotubes, the percolation concentration is typically in the range of from about 0.05% to about 5%, and more typically about 0.5%. Percolation concentration of conductive particles and other high-contrast nanoparticles (i.e., having a high electron density such as metals and atoms having an atomic number greater than about 20) can also be measured using TEM. In TEM, the average number of particles per square micrometer can be counted. In addition, dispersion can be quantified by measuring the average interparticle separation or for plate-like particles direct measurement of thickness and length. Aspect ratio and particle size can also be measured by TEM. A person of skill in the art will also understand how to measure the interfacial strength between the OGN and the polymer matrix (and between the nanoparticle and the polymer matrix as a reference point). Interfacial strength measurements are desirably analyzed separately from improvements in dispersion; for example improvements in interfacial strength can be measured by modulus or impact strength. Modulus or impact strength measurements can be used to infer improvements in interfacial strength. Methods for quantifying the dispersion and interfacial strength of a nanoparticle in a composite material have been described in Kim H, Macosko C M, “Processing-Property Relationships of Polycarbonate/Graphene Composites,” Polymer (2009) and Kim H, Macosko C M, “Morphology and Properties of Polyester/Exfoliated Graphite Nanocomposites,” Macromolecules (2008), the entire contents of which are incorporated herein by reference.

The OGNs are desirably discrete or unagglomerated and dispersible, miscible or otherwise compatible (preferably substantially compatible) with/in the polymeric matrix, and precursors thereto. In some embodiments, the selection of suitable oligomers for providing compatible OGNs for a particular polymeric matrix can be made by matching the solubility parameters of the oligomers to the solubility parameters of the polymeric matrix. Schemes for estimating how well matched the solubility parameters are, include the Van Krevelen parameters of delta d, delta p, delta h and delta v. See, for example, Van Krevelen et al., Properties of Polymers. Their Estimation and Correlation with Chemical Structure, Elsevier Scientific Publishing Co., 1976; Olabisi et al., Polymer-Polymer Miscibility, Academic Press, NY, 1979; Coleman et al., and Specific Interactions and the Miscibility of Polymer Blends, Technomic, 1991. Delta d is a measure of the dispersive interaction of the material, delta p is a measure of the polar interaction of the material, delta h is a hydrogen bonding parameter of the material and delta v is a measurement of both dispersive and polar interaction of the material. Such solubility parameters may either be calculated, such as by the group contribution method, or determined by measuring the cloud point of the material in a mixed solvent system consisting of a soluble solvent and an insoluble solvent. The solubility parameter at the cloud point is defined as the weighted percentage of the solvents. Typically, a number of cloud points are measured for the material and the central area defined by such cloud points is defined as the area of solubility parameters of the material.

In certain embodiments of the present invention, the solubility parameters of the OGNs and that of the composite can be substantially similar. In this case, compatibility between the OGN and the composite may be improved, and phase separation and/or aggregation of the OGN is less likely to occur.

The OGNs may be dispersed in a polymerization solvent used to prepare composite, or they may be isolated by, for example, vacuum evaporation, by precipitation into a non-solvent, and spray drying; the isolated OGNs may be subsequently redispersed within a material appropriate for incorporation into a polymeric matrix to give rise to a composite.

The OGN compositions described herein can be in the form of a particle-dispersion in a fluid. Such a fluid can be an organic liquid or an aqueous liquid. OGNs prepared in a suitable aqueous or non-aqueous fluid can be subsequently dried to a powder form, such as by spray-drying or lyophilization. Hence, the OGN compositions described herein can also be provided as a powder.

Suitable OGN compositions can be used as filler in a polymeric matrix. As filler in a polymeric matrix, OGN compositions of the invention can impart any of a number of properties to the resulting composite. For example, OGN compositions of the invention can impart greater stiffness, toughness, dimensional stability, thermal stability, enhanced electrical conductivity, enhanced thermal conductivity, greater barrier properties, strength, modulus, Tg, chemical corrosion resistance, UV degradation resistance, abrasion resistance, fire resistance or fire retardance, increased electrical conductivity, increased thermal conductivity, increased radio wave deflection, or any combination or subcombination thereof, to the polymer matrix when the oligomer-grafted nanofiller is disposed in the polymer matrix compared to the polymer matrix free of the oligomer-grafted nanofiller. OGN compositions of the invention can be used in the manner and to impart any and all of the properties for which prior art fillers or modifiers have been used.

Methods of making OGN can include reacting a nanoparticle with one or more coupling agents to form a nanoparticle that is attached to one or more coupling agents. Alternatively, functionalized nanoparticles, or nanoparticles attached to one or more coupling agents, can be used as a starting material. Nanoparticles or nanoparticles that are attached to one or more coupling agents can be dispersed in a fluid. The fluid can be aqueous or non-aqueous.

An OGN of the invention can be made by grafting a nanoparticle with one or more oligomers to form the OGN. Methods include reacting relative amounts of oligomer, contacting groups, and nanoparticles sufficient to achieve complete or partial coverage of the surface of the nanoparticle with oligomer. In particular, an amount of coupling group can be reacted with an amount of nanoparticle that will provide oligomer with sufficient attachment points to partially or completely cover the surface of the nanoparticle. The amount of coupling groups, the efficiency of coupling, steric considerations, can affect the degree of surface coverage by oligomer, among other factors. In a non-limiting example, in a functionalization of graphene nanoparticle, an amount of coupling group can be reacted with an amount of nanoparticle that will provide sufficient attachment points to achieve oligomeric coverage of the nanoparticle in a ratio of about one oligomer per every 100 surface carbon atoms, about one oligomer per 70 surface carbon atoms, or about one oligomer per every 40 surface carbon atoms.

Oligomers can be preformed or made separately and then attached to the nanoparticle. Preferably, oligomers that are preformed can be attached to the nanoparticle by being attached to one or more coupling groups or anchoring groups on the nanoparticle. While —OH, —COOH, —NH₂, —C═C, —NCO, epoxide are preferred coupling groups for attaching oligomers, any reactive moiety that can both be attached to a nanoparticle and serve to attach an oligomer can be used in accordance with the invention. Methods for attaching preformed oligomers to coupling groups include, but are not limited to, condensation reactions such as esterification and amidation, and addition reactions, such as free radical addition, atomic transfer radical polymerization reactions, and reversible addition-fragmentation chain transfer reaction.

Alternatively, oligomers can be grown directly on coupling groups that are attached to the nanoparticle. Example coupling agents that can be used to directly grow oligomers include, but are not limited to, organic silanes, di-isocyanates, di-amines, and, for use with clay nanoparticles, and quaternary ammonium.

Once the oligomer has been linked or bonded to the nanoparticle some or all of the fluid can be removed from the OGNs. Keeping the OGNs in at least some fluid can prevent aggregation of the OGN particles.

In another embodiment of the invention, a composite material includes a polymer matrix and one or more OGNs dispersed within the polymer matrix. The one or more OGNs have been described above. Composite materials of the invention can have greater stiffness, toughness, dimensional stability, thermal stability, enhanced electrical conductivity, enhanced thermal conductivity, greater barrier properties, strength, modulus, Tg, chemical corrosion resistance, UV degradation resistance, abrasion resistance, fire resistance or retardance, increased electrical conductivity, increased thermal conductivity, increased radio wave deflection, or any combination or subcombination thereof, as compared to a composite material that is a polymer matrix including nanoparticles that do not have oligomers grafted thereto. Thus, the OGNs can impart desired properties to the polymer matrix or resulting composite material.

While composite materials of the invention can have any amount of OGN sufficient to impart a desired property to the composite material, preferably composite materials of the invention can have a weight percent of the OGN based on the total weight of the composite in the range of from about 0.005% to about 20%, or more preferably in the range of from about 0.01% to about 0.5%, or even more preferably, in the range of from about 0.001% to about 1%.

In compositions of the invention, one or more OGNs can be attached or bonded to the host polymer matrix. OGNs can be covalently bonded to the polymer matrix or ionically bonded of the polymer matrix. OGNs can be attached to the polymer matrix through van der Waals forces. The OGNs can be attached to the polymer matrix by way of covalent or ionic bonding of one or more oligomers of the one or more OGN to the polymer matrix or by van der Waals interactions between one or more oligomers of the one or more OGN and the polymer matrix.

The present invention also includes methods for making a composite material that includes one or more OGNs dispersed in a host polymer matrix. A method for making an OGN-polymer composite can include dispersing an OGN in a polymer matrix that includes one or more polymerizable units and effectuating bonding between the oligomers and the polymer matrix. Any OGN of the invention can be used in methods for making a composite material, such as OGN including oligomers that can improve dispersion, interfacial strength, or both dispersion and interfacial strength between the nanoparticle and the polymer matrix, or oligomers that are derived from two or more polymerizable units where at least one polymerizable unit can be at least substantially similar to at least one of the polymerizable units of the polymer matrix. Dispersing techniques include, but are not limited to, solvent blending and melt compounding. Methods of making an OGN-polymer composite can further include the step of effectuating bonding between the oligomers and the polymer matrix.

Suitable composite materials can also be made by dispersing OGNs in a plurality of monomers and subsequently carrying out a chemical reaction to polymerize the monomers. The OGNs can be applied to the host polymer by direct mixing in the monomer for the target polymer matrix. Alternatively, they can be applied through a master-batch approach, in which OGNs are dispersed at a high concentration in the monomer and the target formulation can then be achieved by diluting the master-batch with monomer. The monomers can be dispersed in a fluid, such as an aqueous or non-aqueous fluid. The chemical reaction appropriate for polymerizing the monomers after addition of the OGNs will depend on the nature of the monomers, but can be, for example, thermally initiated or photo-initiated. In some methods of the invention, the polymerizing step can give rise to at least one covalent bond between the oligomer portion of the oligomer-grafted nanofiller and the polymerized monomer.

Once the OGNs are incorporated in the polymer matrix, the interface between OGN and polymer becomes indistinguishable from the bulk phase and the overall nanocomposite will consist of highly dispersed nanofiller particles in a single phase.

In another embodiment of the invention, an article or workpiece can be made from a composite material of OGN and polymer.

### EXAMPLES

The following examples, while illustrative individual embodiments, are not intended to limit the scope of the described invention, and the reader should not interpret them in this way.

### Example 1

### Functionalization of Graphene Oxide Nanoparticle with Polybutadiene-Polyacrylonitrile Rubber Oligomer

The example is to attach a polybutadiene-polyacrylonitrile rubber oligomer on graphene oxide with a coupling agent. To functionalize graphene oxide (GO) with rubber oligomer, 0.2 g of GO was dispersed in 50 mL dimethyl formamide (DMF) by sonication, then 2 g of methylene diphenyl diisocyanate (MDI) was added. The mixture was stirred at room temperature for one day, and was then coagulated by methylene chloride. After being washed with methylene chloride at least five times by centrifugation, the isocyanate-functionalized GO was then redispersed in 100 mL of DMF. An amount of 4 g of amine-terminated polybutadiene-polyacrylonitrile (ATBN 1300×42, molecular weight 900 g/mol, 18% polyacrylonitrile), was added and the mixture was stirred at 50° C. for 12 h. ATBN-functionalized GO was separated by centrifugation and washed by with acetone for at least 5 times. The product was dispersed in t-butanol and the dispersion was subjected to freeze drying for at least 15 h at room temperature and then 3 h at 60° C. The product was obtained as a fluffy powder.

Referring now to FIG. 5, a schematic of the functionalization of graphene oxide (GO) is illustrated. At the top left, graphene oxide is provided with hydroxyl and carboxyl functionalities circled. Methylene diphenyl diisocyanate (MDI) is added to the GO to produce isocyanate-functionalized GO (MDI-GO) Amine-terminated polybutadiene-polyacrylonitrile (ATBN) is added to the MDI-GO to form ATBN-GO. FIG. 5A shows the structure of ATBN.

Structural characterization is shown in FIGS. 6 and 7. FIG. 6 shows the FT-IR spectra of ATBN-GO, GO-NCO, compared with the FT-IR spectrum of GO. The peak corresponding to —CH₂—is pointed out on the ATBN-GO spectrum and the peak corresponding to —NCO is pointed out on the GO-NCO spectrum. FIG. 7 shows the x-ray diffraction spectra of ATBN-GO, MDI-GO, and GO.

The functionalization density of ATBN on GO was estimated by thermogravimetric analysis (TGA) and is shown in Table 1. In calculating the functionalization density per 100 carbon atoms, the following assumptions were made: 1) only carbon was left after 800° C. and 2) the structure of the functional group is:

[chemical structure]

TABLE 1

| | Weight Loss | Functionalization Density/ |
|---|---|---|
| Sample | (250° C.-800° C.)/wt % | per 100 carbon atoms |
| GO | 17.9 | NA |
| ATBN-GO | 37.3 | 0.39 |

### Example 2

### Preparation of a Composite Material Using the OGNs of Example 1

The desired amount of ATBN-functionalized GO is dispersed in THF by ultra-sonication, then the dispersion is added to a THF solution of polybutadiene-polyacrylonitrile copolymer to achieve a final composite with 0.005 wt % to 20 wt % of modified graphene oxide. After solvent evaporation or precipitation in a non-solvent, such as methanol, the composite is obtained.

### Example 3

### Functionalization of Graphene Nanoparticle with Styrene Oligomer

To grow oligomeric styrene on graphene, silylation of graphene is achieved by stirring graphene oxide and 3-chloropropyl trimethoxy silane in ethanol at 60° C. for 12 h. Then the chlorine-functionalized graphene is dispersed in DMF with CuCl and styrene for atom transfer radical polymerization (ATRP) reaction.

### Example 4

### Functionalization of Graphene Nanoparticle with Polyester Oligomer

To grow oligomeric polyester on graphene, a similar approach as to diamine functionalization of graphene oxide is used; a substitution of diamine to hydroxyl-terminated polyester oligomer produces polyester-functionalized GO.

### Example 5

### Functionalization of Graphene Nanoparticle with Ethylene Oxide Oligomer

To grow oligomeric polyester on graphene, a similar approach as to diamine functionalization of graphene oxide is used; a substitution of diamine with polyethylene glycol (PEG) or polyethylene oxide (PEO) produces PEG/PEO-functionalized GO.

### Example 6

### Functionalization of Graphene Nanoparticle with Acrylic or Methacrylate Oligomer

To grow oligomeric acrylic or methacrylate on graphene, a similar approach as to polystyrene functionalization of graphene oxide is used; a substitution of styrene to acrylic/methacrylate monomers produces acrylic/methacrylate oligomer-functionalized GO.

### Example 7

### Functionalization of Graphene Nanoparticle with Vinyl Ester Oligomer

To grow oligomeric vinyl ester on graphene, a similar approach as to polystyrene functionalization of graphene oxide is used; a substitution of styrene to vinyl ester will produce vinyl ester functionalized GO.

### Example 8

### Functionalization of Graphene Nanoparticle with Epoxy Oligomer

To grow oligomeric epoxy on graphene, diamine-functionalized GO is used and a further reaction with epoxy resin grafts epoxy monomer on GO.

### Example 9

### Functionalization of Graphene Nanoparticle with Aramid Oligomer

To grow oligomeric aramid on graphene, a similar approach as to diamine functionalization of graphene oxide is used; a substitution of diamine with amine-terminated aramid oligomer produces aramid-functionalized GO.

### Example 10

### Functionalization of Carbon Nanotube with Oligomer

Carbon nanotubes (CNT) are treated in concentrated nitric acid to produce hydroxyl groups and carboxyl groups on CNT.

Alternatively, carbon nanotubes (CNT) are treated in a mixture of phenylene diamine/4-hydroxylethyl aniline and isoamyl nitrite in organic solvent to produce amino/hydroxyl groups on CNT.

After generating hydroxyl or amino groups on the carbon nanotube surface, oligomer can be grafted to the carbon nanotube surface using a similar approach as for graphene oxide in the above methods.

### Example 11

### Functionalization of Carbon Nanofiber with Oligomer

Carbon nanofibers are treated in a similar approach as carbon nanotubes of Example 10.

### Example 12

### Functionalization of Graphene Sheet with Oligomer

Graphene sheets are treated in a similar approach as carbon nanotubes of Example 10.

### Example 13

### Functionalization of Graphite Nanoparticle with Oligomer

Graphene nanoparticles are converted to graphene oxide after treatment in a mixture of concentrated sulfuric acid and potassium permanganate (the Hummers' method). The graphene oxide particles are then functionalized in accordance with Examples 1-9.

### Example 14

### Functionalization of Silica Nanoparticle with Oligomer

Silica nanoparticles are treated with 3-aminopropyl trimethoxysilane in ethanol to generate amino groups on the silica nanoparticle surface. After generating amino groups on the silica nanoparticle surface, oligomer can be grafted to the silica nanoparticle surface using a similar approach as for graphene oxide in the above methods.

### Example 15

### Functionalization of Metal Oxide Nanoparticle with Oligomer

Metal oxide nanoparticles are treated using a similar approach as for silica nanoparticles in the Example 14.

### Example 16

### Functionalization of Layered Silicates Nanoparticle with Oligomer

Refluxing the layered silicate nanoparticles with a solution of alkylammonium halide exchanges the interlayer metal cations to alkylammonium cation. Using octadecyl bis(2-hydroxylethyl)methyl ammonium chloride, hydroxyl group is generated on the surface of the layered silicates nanoparticle. After generating hydroxyl groups on the layered silicates surface, oligomer can be grafted to the layered silicates nanoparticle surface using a similar approach as for graphene oxide in the above methods.

### Example 17

### Functionalization of Clay Nanoparticle with Oligomer

Clay nanoparticles are treated using a similar approach as for layered silicates in Example 16.

Alternatively, oligomer can be grafted to a commercial organoclay, such as Cloisite 30B, which has two hydroxyl groups on each organic modifier, using a similar approach as for graphene oxide in the above methods.

### Example 18

### Functionalization of Layered Chalcogenide Nanoparticle with Oligomer

Terpyridine derivatives are used to chelate the surface metal atoms on chalcogenide particles. Hydroxyl groups are generated if the terpyridine derivative contains terminal hydroxyl groups. After generating hydroxyl groups on the chalcogenide particle surface, oligomer can be grafted to the chalcogenide particle surface using a similar approach as for graphene oxide in the above methods.

### Example 19

### Functionalization of Ceramic Nanoparticle with Oligomer

Ceramic nanoparticles are treated in nitric acide to activate surface hydroxyl groups. After generating hydroxyl groups on the ceramic nanoparticle surface, oligomer can be grafted to the ceramic nanoparticle surface using a similar approach as for graphene oxide in the above methods.

### Example 20

### Functionalization of Metal Nanoparticles with Oligomer

Metal nanoparticles are treated with long-chain thiols (e.g., C-12, C-16, or C-18 thiol) containing a reactive group on the opposite end to attach oligomers.

It is to be understood that while the invention has been described in conjunction with the preferred specific embodiments thereof, that the foregoing description and the examples that follow are intended to illustrate and not limit the scope of the invention. It will be understood by those skilled in the art that various changes may be made and equivalents may be substituted without departing from the scope of the invention, and further that other aspects, advantages and modifications will be apparent to those skilled in the art to which the invention pertains. In addition to the embodiments described herein, the present invention contemplates and claims those inventions resulting from the combination of features of the invention cited herein and those of the cited prior art references which complement the features of the present invention. Similarly, it will be appreciated that any described material, feature, or article may be used in combination with any other material, feature, or article, and such combinations are considered within the scope of this invention.

The disclosures of each patent, patent application, and publication cited or described in this document are hereby incorporated herein by reference, each in its entirety, for all purposes.

1. An oligomer-grafted nanofiller composition for disposition in a polymer matrix, the polymeric matrix comprising polymers derived from a plurality of polymerizable units, the nanofiller composition comprising:
a nanoparticle;
one or more coupling groups bonded to the nanoparticle; and
one or more oligomers bonded to the one or more coupling groups, wherein the oligomers are derived from two or more polymerizable units, at least one polymerizable unit being at least substantially similar to at least one of the polymerizable units of the polymer matrix.

2. The oligomer-grafted nanofiller composition according to claim 1, wherein the nanoparticle is a carbonaceous nanoparticle.

3. The oligomer-grafted nanofiller composition according to claim 2, wherein the carbonaceous nanoparticle comprises a single-walled carbon nanotube, multi-walled carbon nanotube, carbon nanofiber, graphene sheet, graphene oxide nanoparticle, graphite nanoparticle, fullerene particle, carbon black, activated carbon, or any combination or subcombination thereof.

4. The oligomer-grafted nanofiller composition according to claim 1, wherein the nanoparticle comprises silica, metal oxide, layered silicate, clay, layered chalcogenide, or any combination or subcombination thereof.

5. The oligomer-grafted nanofiller composition according to claim 1, wherein the one or more coupling groups are covalently bonded to the nanoparticle.

6. The oligomer-grafted nanofiller composition according to claim 1, wherein the one or more coupling groups are ionically bonded to the nanoparticle.

7. The oligomer-grafted nanofiller composition according to claim 1, comprising about one coupling group for about every 40 carbon atoms on a surface of the nanoparticle.

8. The oligomer-grafted nanofiller composition according to claim 1, wherein the coupling group comprises one or more of the following functional groups: —OH, —COOH, —NH₂, —C═C, —NCO, or epoxide.

9. The oligomer-grafted nanofiller composition according to claim 1, wherein the coupling group comprises an organic silane, di-isocyanate, di-amine, or quaternary amine.

10. The oligomer-grafted nanofiller composition according to claim 1, wherein the coupling group is dendritic.

11. The oligomer-grafted nanofiller composition according to claim 10, wherein the dendritic coupling group comprises a polyamine, a polyisocyanate, a polyol, or any combination thereof.

12. The oligomer-grafted nanofiller composition according to claim 1, wherein the one or more oligomers are covalently bonded to the one or more coupling groups.

13. The oligomer-grafted nanofiller composition according to claim 1, wherein the one or more oligomers are ionically bonded to the one or more coupling groups.

14. The oligomer-grafted nanofiller composition according to claim 1, wherein the two or more polymerizable units of the polymer matrix are all substantially the same.

15. The oligomer-grafted nanofiller composition according to claim 1, wherein two or more of the polymerizable units of the polymer matrix are substantially different.

16. The oligomer-grafted nanofiller composition according to claim 15, wherein two or more of the oligomers each comprises two or more polymerizable units, at least one polymerizable unit of the two or more oligomers being at least substantially similar to each of the two or more substantially different polymerizable units of the polymeric matrix.

17. The oligomer-grafted nanofiller composition according to claim 16, wherein the two or more of the oligomers each comprise two or more of the same polymerizable units.

18. The oligomer-grafted nanofiller composition according to claim 1, wherein the oligomer-grafted nanofiller is in the form of a powder.

19. The oligomer-grafted nanofiller composition according to claim 1, wherein the oligomer-grafted nanofiller is in the form of a particle-dispersion in a fluid.

20. The oligomer-grafted nanofiller composition of claim 19, wherein the fluid is an organic liquid or an aqueous liquid,

21. The oligomer-grafted nanofiller composition according to claim 1, wherein the oligomer-grafted nanofiller imparts one or more of the following properties to the polymer matrix when the oligomer-grafted nanofiller is disposed in the polymer matrix compared to the polymer matrix free of the oligomer-grafted nanofiller: greater stiffness, greater toughness, greater dimensional stability, greater thermal stability, enhanced electrical conductivity, enhanced thermal conductivity, and greater barrier properties.

22. The oligomer-grafted nanofiller composition according to claim 1, wherein the amount of the one or more oligomers attached to the nanoparticle through the coupling agents is in a range appropriate to achieve complete or partial surface coverage of the nanoparticle by the oligomers.

23. The composite according to claim 1, wherein the nanoparticle comprises surface carbon atoms, wherein the number density of oligomers attached to the nanoparticle through the coupling agents is in the range of from about 1 oligomer per 10 surface carbon atoms to about 1 oligomer per 10,000 surface carbon atoms, and preferably about 1 to 2 oligomers per 200 surface carbon atoms.

24. The composite according to claim 23, wherein the mass fraction of the one or more oligomers and coupling agents is in a range of from about 2% to about 90%, and more preferably in a range of from about 5% to about 80%, as measured by thermogravimetric analysis.

25. The composite according to claim 1, wherein the average number of repeat groups of the one or more oligomers attached to the nanoparticle through the one or more coupling groups is in the range of from about 2 to about 100.

26. The composite according to claim 1, wherein the average number of repeat groups of the one or more oligomers attached to the nanoparticle through the one or more coupling groups is in the range of from about 10 to about 20.

27. An oligomer-grafted nanofiller composition for disposition in a polymer matrix, the polymeric matrix comprising two or more polymerizable units, the nanofiller composition comprising:
a nanoparticle;
one or more coupling groups bonded to the nanoparticle; and
one or more oligomers bonded to the one or more coupling groups, wherein the oligomer comprises two or more polymerizable units and improves dispersion, interfacial strength, or both dispersion and interfacial strength between the nanoparticle and the polymer matrix.

28. The oligomer-grafted nanofiller composition according to claim 27, wherein the nanoparticle is a carbonaceous nanoparticle.

29. The oligomer-grafted nanofiller composition according to claim 28, wherein the carbonaceous nanoparticle comprises a single-walled carbon nanotube, multi-walled carbon nanotube, carbon nanofiber, graphene sheet, graphene oxide nanoparticle, graphite nanoparticle, or a combination or subcombination thereof.

30. The oligomer-grafted nanofiller composition according to claim 27, wherein the nanoparticle is silica or metal oxide nanoparticles, clays, layered silicates, layered chalcogenides, metal nanoparticles, or a combination or subcombination thereof.

31. The oligomer-grafted nanofiller composition according to claim 27, wherein the one or more coupling groups are covalently bonded to the nanoparticle.

32. The oligomer-grafted nanofiller composition according to claim 27, wherein the one or more coupling groups are ionically bonded to the nanoparticle.

33. The oligomer-grafted nanofiller composition according to claim 1, comprising about one coupling group for about every 40 carbon atoms on a surface of the nanoparticle.

34. The oligomer-grafted nanofiller composition according to claim 27, wherein the coupling group comprises —OH, —COOH, NH₂, —C═C, —NCO, or epoxide.

35. The oligomer-grafted nanofiller composition according to claim 27, wherein the coupling group comprises an organic silane, di-isocyanate, di-amine, or quaternary amine.

36. The oligomer-grafted nanofiller composition according to claim 27, wherein the coupling group is dendritic.

37. The oligomer-grafted nanofiller composition according to claim 36, wherein the dendritic coupling group comprises a polyamine, polyisocyanate or polyol.

38. The oligomer-grafted nanofiller composition according to claim 27, wherein the one or more oligomers are covalently bonded to the one or more coupling groups.

39. The oligomer-grafted nanofiller composition according to claim 27, wherein the one or more oligomers are ionically bonded to the one or more coupling groups.

40. The oligomer-grafted nanofiller composition according to claim 27, wherein the oligomer-grafted nanofiller is in the form of a powder.

41. The oligomer-grafted nanofiller composition according to claim 27, wherein the oligomer-grafted nanofiller is in the form of a particle-dispersion fluid.

42. The oligomer-grafted nanofiller composition according to claim 27, wherein at least one or more oligomers imparts grafted nanofiller imparts greater stiffness, toughness, dimensional and thermal stability, electrical and thermal conductivity to the polymer matrix when the oligomer-grafted nanofiller is disposed in the polymer matrix.

43. The composite according to claim 27, wherein the one or more oligomers attached to the nanoparticle through the coupling agents is in a range appropriate to achieve complete or partial surface coverage.

44. The composite according to claim 27, wherein the nanoparticle comprises surface carbon atoms, wherein the amount of the one or more oligomers attached to the nanoparticle through the coupling agents is in the range of from about 1 oligomer per 10 surface carbon atoms to about 1 oligomer per 10,000 surface carbon atoms, and preferably about 1 to 2 oligomers per 200 surface carbon atoms.

45. The composite according to claim 27, wherein the average number of repeating units in one or more oligomers attached to the nanoparticle through the one or more coupling groups is from about 2 to about 100.

46. The composite according to claim 27, wherein the average number of repeating units in one or more oligomers attached to the nanoparticle through the one or more coupling groups is from about 10 to about 20.

47. A composite, comprising:
a polymer matrix; and
one or more oligomer-grafted nanofillers dispersed within the polymer matrix, wherein the oligomer-grafted nanofiller comprises a nanoparticle, one or more coupling groups bonded to the nanoparticle, and one or more oligomers bonded to the one or more coupling groups.

48. The composite of claim 47, wherein the weight percent of the oligomer-grafted nanofillers based on total weight of the composite is in the range of from 0.005% to 20%.

49. The composite according to claim 47, wherein the oligomers are derived from two or more polymerizable units, at least one polymerizable unit being at least substantially similar to at least one of the polymerizable units of the polymer matrix.

50. The composite according to claim 47, wherein the oligomers are derived from two or more polymerizable units, the oligomers giving rise to improved dispersion, interfacial strength, or both, between the nanoparticle and the polymer matrix.

51. The composite according to claim 47, wherein the oligomer-grafted nanofiller is covalently bonded to the polymer matrix.

52. The composite according to claim 47, wherein the oligomer-grafted nanofiller is ionically bonded to the polymer matrix.

53. The composite according to claim 47, wherein the oligomer-grafted nanofiller interacts with the polymer matrix through van der Waals forces.

54. The composite according to claim 47, wherein the nanoparticle is a carbonaceous nanoparticle.

55. The composite according to claim 54, wherein the carbonaceous nanoparticle comprises a single-walled carbon nanotube, multi-walled carbon nanotube, carbon nanofiber, graphene sheet, graphene oxide nanoparticle, graphite nanoparticle, or a combination or subcombination thereof.

56. The composite according to claim 47, wherein the nanoparticle is silica, metal oxide particles, layered silicate, clay, layered chalcogenide or a combination or subcombination thereof.

57. The composite according to claim 47, wherein the one or more coupling groups are covalently bonded to the nanoparticle.

58. The composite according to claim 47, wherein the one or more coupling groups are ionically bonded to the nanoparticle.

59. The composite according to claim 47, wherein the coupling group comprises —OH, —COOH, NH₂, —C═C, —NCO, or epoxide.

60. The composite according to claim 47, wherein the coupling group comprises an organic silane, di-isocyanate, di-amine, or quaternary amine.

61. The composite according to claim 47, wherein the coupling group is dendritic.

62. The composite according to claim 61, wherein the dendritic coupling group comprises a polyamine, polyisocyanate or polyol.

63. The composite according to claim 47, wherein the one or more oligomers are covalently bonded to the one or more coupling groups.

64. The composite according to claim 47, wherein the one or more oligomers are ionically bonded to the one or more coupling groups.

65. The composite according to claim 47, wherein the two or more polymerizable units of the polymer matrix are all substantially the same.

66. The composite according to claim 47, wherein two or more of the polymerizable units of the polymer matrix are substantially different.

67. The composite according to claim 66, wherein two or more of the oligomers each comprises two or more polymerizable units, at least one polymerizable unit of the two or more oligomers being at least substantially similar to each of the two or more substantially different polymerizable units of the polymeric matrix.

68. The composite according to claim 67, wherein the two or more of the oligomers each comprise two or more of the same polymerizable units.

69. The composite according to claim 47, wherein at least one or more oligomers grafted nanofiller imparts one or more of the following properties, greater stiffness, toughness, dimensional stability, thermal stability, enhanced electrical conductivity, enhanced thermal conductivity, and greater barrier properties to the polymer matrix when the oligomer-grafted nanofiller is disposed in the polymer matrix.

70. The composite according to claim 47, wherein the mass ratio of oligomer-grafted nanoparticles to polymer is from 0.005% to 20%.

71. The composite according to claim 47, wherein the average number of repeating units in oligomers attached to the nanoparticle through the one or more coupling groups is in the range of about 2 to about 100.

72. The composite according to claim 47, wherein the average number of repeating units in oligomers attached to the nanoparticle through the one or more coupling groups is in the range of about 10 to about 20.

73. A method for making an oligomer-grafted nanofiller comprising:
grafting a nanoparticle with one or more oligomers to form the oligomer-grafted nanofiller.

74. The method according to claim 73, further comprising dispersing the nanoparticle that is bonded to one or more coupling agents in a fluid.

75. The method according to claim 74, wherein the fluid is aqueous.

76. The method according to claim 74, wherein the fluid is non-aqueous.

77. The method according to claim 73, further comprising contacting a nanoparticle with a coupling agent to form a nanoparticle that is bonded to one or more coupling agents.

78. The method according to claim 77, further comprising dispersing the nanoparticle in a fluid before contacting the nanoparticle with a coupling agent.

79. The method according to claim 78, wherein the fluid is aqueous.

80. The method according to claim 78, wherein the fluid is non-aqueous.

81. The method according to claim 74, further comprising removing substantially all of the fluid from the dispersion of the nanoparticle.

82. A method for making an oligomer-grafted nanofiller comprising:
reacting a nanoparticle with one or more coupling agent to form a coupling agent-bonded nanoparticle; and
reacting the coupling agent-bonded nanoparticle with one or more oligomers to form the oligomer-grafted nanofiller.

83. The method according to claim 82, wherein the number ratio of oligomers to nanoparticles is in a range appropriate to achieve complete or partial surface coverage.

84. The method according to claim 82, further comprising dispersing the oligomer-grafted nanofiller in a fluid.

85. The method according to claim 84, wherein the fluid is aqueous.

86. The method according to claim 84, wherein the fluid is non-aqueous.

87. The method according to claim 84, further comprising removing substantially all fluid from the dispersion of the oligomer-grafted nanofiller.

88. The method according to claim 82, further comprising growing one or more oligomers on the one or more coupling agents of the nanoparticle.

89. The method according to claim 88, wherein the growing step is performed through a condensation reaction.

90. The method according to claim 89, wherein the condensation reaction is esterification.

91. The method according to claim 89, wherein the condensation reaction is amidation.

92. The method according to claim 88, wherein the growing step is performed through an addition reaction.

93. The method according to claim 92, wherein the addition reaction is a free radical addition reaction.

94. The method according to claim 92, wherein the addition reaction is an atomic transfer radical polymerization reaction.

95. The method according to claim 92, wherein the addition reaction is a reversible addition-fragmentation chain transfer reaction.

96. A method for depositing oligomer-grafted nanofiller in a polymer matrix comprising:
dispersing the oligomer-grafted nanofiller in the polymer matrix,
wherein the polymer matrix comprises one or more polymerizable units;
wherein the oligomer-grafted nanofiller comprises a nanoparticle and one or more oligomers covalently bonded to the nanoparticle, optionally through a coupling agent; and
wherein the one or more oligomers are derived from two or more polymerizable units, wherein the one or more oligomers improve dispersion, interfacial strength, or both dispersion and interfacial strength between the nanoparticle and the polymer matrix.

97. The method according to claim 96, wherein dispersing is performed by solvent blending.

98. The method according to claim 97, wherein dispersing is performed by melt compounding.

99. A method for making a composite, comprising:
dispersing an oligomer-grafted nanofiller in a polymer matrix,
wherein the polymer matrix comprises one or more polymerizable units;
wherein the oligomer-grafted nanofiller comprises a nanoparticle and one or more oligomers covalently bonded to the nanoparticle, optionally through a coupling agent; and
wherein the one or more oligomers are derived from two or more polymerizable units, at least one polymerizable unit being at least substantially similar to at least one of the polymerizable units of the polymer matrix; and
effectuating bonding between the oligomers and the polymer matrix.

100. The method according to claim 99, wherein dispersing is performed by solvent blending.

101. The method according to claim 99, wherein dispersing is performed by melt compounding.

102. A method for making a composite, comprising:
dispersing an oligomer-grafted nanofiller in a fluid comprising one or more monomers, the oligomer portion of the oligomer-grafted nanofiller being derived from at least one polymerizable unit corresponding to the one or more monomers; and
polymerizing the monomer.

103. The method according to claim 102, wherein the polymerizing step is thermally initiated.

104. The method according to claim 102, wherein the polymerizing step is photo-initiated

105. The method of claim 102, wherein the step of polymerizing the monomer gives rise to at least one covalent bond between the oligomer portion of the oligomer-grafted nanofiller and the polymerized monomer.

106. An article made from an oligomer-grafted nanofiller composite according to claim 47.

107. An article made from an oligomer-grafted nanofiller composite according to claim 54.

108. An article made from an oligomer-grafted nanofiller composite according to claim 55.

109. An article made from an oligomer-grafted nanofiller composite according to claim 63.

110. An article made from an oligomer-grafted nanofiller composite according to claim 66.

111. An article made from an oligomer-grafted nanofiller composite according to claim 67.
